(19) United States
(12) Patent Application Publication
(10) Pub. No.: US 2006/0267715 A1
(43) Pub. Date: Nov. 30, 2006

(54) Magnetic field generating system applicable to nuclear magnetic resonance device

(76) Inventors: Cheng Ni, Shenzhen (CN); Ting Qiang Xue, Shenzhen (CN)

Correspondence Address: SCHIFF HARDIN, LLP;PATENT DEPARTMENT, 6600 SEARS TOWER, CHICAGO, IL, 60606-6473, US

(21) Appl. No.: 10/557,818

(22) PCT Filed: May 21, 2004
(86) PCT No.: PCT/EP04/05512

§ 371 Date: Nov. 23, 2005

(30) Foreign Application Priority Data
May 23, 2003 (CN) 03136673.2

(51) Int. Cl. H01F 3/00

(52) U.S. Cl. 335/297

(57) ABSTRACT

A magnetic field generating system suitable for use in a magnetic resonance apparatus has mirror-symmetrical assemblies disposed at opposite faces of a supporting structure, each assembly having a pole plate located between a pulsed magnetic field excitation coil and a static magnetic field generating source. Each pole plate is formed by a number of pole plate segments that either electrically insulated from each other, or conduct between adjacent segments only at single points, without forming a conductive loop. Eddy current propagation is thereby suppressed.

### BACKGROUND OF THE INVENTION

1. Field of the Invention

The present invention relates to a magnetic resonance device and to a magnetic field generating system in other magnetic generating devices in which the unwanted effect of the pulsed electromagnetic field caused by pulse induced electrical current needs to be reduced, and more particularly, relates to a pole plate unit located between the magnet and the pulse excitation coil in such a device.

2. Description of the Prior Art

For explaining the principle and system of the present invention, a permanent magnet in the magnetic resonance equipment is used as an example. However, the present invention is applicable not only to magnetic resonance imaging equipment and other types of magnetic resonance imaging equipment, but also to a magnetic generating device in any type of electromagnetic equipment in which the unwanted effect of a pulse induced magnetic field needs to be reduced.

In magnetic resonance imaging equipment, spatial information for the detected signal is produced by means of the gradient field generated by gradient coil and through appropriate mathematical transformations (such as Fourier Transformation). However, when current is applied to the gradient coil to generate a pulsed magnetic field, an eddy current will be induced in the conductive structure of the permanent magnet and an accompanying magnetic field or even residual magnetism will be generated. The induced magnetic field will destroy the original magnetic field profile of the permanent magnet and thereby degrade the quality of the image of the examination subject generated by the magnetic resonance imaging equipment. In magnetic resonance imaging equipment of the type known as an open system, the permanent magnet is provided between two pole plates and a press plate. For example, in a C-shaped permanent magnet (i.e., having a horseshoe shape with one end open), two groups of magnets are provided between the pole plates and press plates located at the two sides (upper and lower sides) of the central area in which the examination subject is located. The press plates are mounted on both end surfaces of magnetic yoke. The pole plate, press plate and the magnetic yoke are usually made of soft magnetic material to satisfy the two requirements of good magneto-conductivity and strong mechanical structure. The magnetic field generating source could be either a permanent magnet or an electric coil and the soft magnetic material could be, for example, steel or iron; but steel and iron having good magneto-conductivity are also good electric conductors, so eddy currents will be generated due to the effect of the pulsed electro-magnetic field. In order to reduce the eddy current effect in the pole plates, it is known to provide a pole piece between the pole plate and the gradient coil, the pole piece usually being made of material having good magneto-conductivity but bad electric conductivity, for example, the materials such as laminated silicon steel sheet, ferrite, powdered iron compound, etc. as disclosed in U.S. Pat. Nos. 6,215,382, 5,368,078 and U.S. Pat. Nos. 5,729,188, and 5,680,086 and EP 0 645 641 A1. Nevertheless, the pulse gradient field could still partially penetrate the pole piece and reach the pole plate to generate eddy currents therein, and thereby degrade the quality of image.

### SUMMARY OF THE INVENTION

An object of the present invention is to provide an improved pole plate, that has good magneto-conductivity and strong mechanical structure, and that effectively prevents eddy current generation and residual magnetism therein.

The above object is achieved in accordance with the present invention by a magnetic field generating system having a magnetic field generating source, a pulse excitation coil and a pole plate, the pole plate being located between the pulse excitation coil and the magnetic field generating source, and the pole plate being composed of a number of pole plate segments that are electrically insulated or conducting only at single point without forming an electrically conductive loop.

In the magnetic field generating system of the present invention, the shape of the magnet can be an open C shape, multiple poles forming a plate shape or horizontal laminations. The magnetic field generating source can be a permanent magnet or can be composed of electrically conductive coils. The pole plate is located between the pulse excitation coil and the magnetic field generating source with the function of providing magnetic conductive path and mechanical structural strength.

Since the problem to be solved is to form a magnetic conductive path without forming an electrically conductive loop, the magnetic field generating system of the present invention can be used both for magnetic resonance imaging equipment and for other magnetic field generating devices having pulse excitation coils.

In the magnetic field generating system of the present invention, part of said pole plate can be a number of interleaving arc-shaped segments, or circles like gradient coils, or other varying shapes such as spoke shapes or interleaving radiating shapes. The principle of the present invention is to block the eddy current conductive loop in the pole plate while maintaining the magneto-conductivity and mechanical strength of the pole plate.

In embodiments of the invention the pole plate segments, as part of the pole plate, are disposed symmetrically with respect to the axis (magnet axis) through the center of the magnet pole; the pole plate as a whole can also be symmetrical along an axis within the plane of the pole plate that is orthogonal to the magnet axis; also the pole plate as a whole can be symmetrical along an axis within the plane of the pole plate that is orthogonal to both the axis of the magnet and the first axis in the plane of the pole plate. Based on this principle of the invention, the layout of the pole plate segments can be varied to other shapes, such as a radiating shape or partially axial symmetrical shape in some particular cases.

In a further embodiment of the invention each of the pole plate segments is made by cutting slits in the entire pole plate base to a certain depth but not penetrating, or by putting together the desired shapes pre-fabricated from soft magnetic materials and then fixing them to the pole plate base by screws or other mechanical methods such as tessellating or adhering to form the pole plate segment. The pole plate segments are electrically insulated or conducting only at single points but without forming a conducting loop, which can be accomplished by employing insulating chips or by an insulating layer coated on the surface of the pole plate segments.

The widths of pole plate segments in the system provided by the present invention range from 5 mm to 200 mm, and the gaps between the pole plate segments should be less than 1 cm, because too large a gap will destroy the mechanical strength and the magneto-conductivity.

In the system of the present invention, there can be a pole piece between the pole plate and the gradient coil, and a shimming Rose ring can be provided external to the edge of the plane on the pole piece.

The object of the present invention is to improve the pole plate. Pole plates of the prior art are composed of continuous soft ferromagnetic material, while according to the solution of the present invention, a part of the circular disk is cut into a plurality of segments for the purpose of blocking the eddy current.

Theoretically, the more fragmented the pole plate is, the better the effect of blocking the eddy current. But if the pole plate is cut so as to be too fragmented, the magneto-conductivity and mechanical strength of the pole plate will be reduced, and the costs for processing and assembling will be increased. Therefore, the cutting of the pole plate must not result in an overly fragmented plate.

The pole plate functions in the permanent magnet both as magnetic conducting as well as for holding the magnet material in the permanent magnet in a mechanical sense. When designing the cutting pattern of the pole plate, the gap between the cutting blocks should be set appropriately, because too small gap will be unfavorable for assembling and will make it difficult to realize electrical insulation between the blocks, while too large a space will cause undesirable reduction of the magneto-conductivity and the mechanical strength.

In order to promote homogeneity of the magnetic field, the cut pole plate should be symmetrical along the central axis through the center of the magnet pole, preferably symmetrical along one axis or two orthogonal axes on the plane of the pole plane. Cutting in the axial symmetrical manner keeps the magnetic field as homogeneous as possible; similarly, particular requirements on the magnetic field also can be satisfied by intentionally cutting in a non-symmetrical manner by making use of the non-symmetry of the magnetic field in the design of the magnet.

As usual herein “cutting” does not necessarily mean physically cutting the pole plate, but encompassing any technique to cause the formed “pattern” of pole plate to resemble “cutting” a circular disk.

### DESCRIPTION OF THE DRAWINGS

FIG. 1 is a side view of a magnetic resonance apparatus having a C-shape magnetic system in accordance with the present invention, and showing an enlargement of the components of the magnetic system.

FIG. 2 is a perspective view of a first embodiment of a structure for the pole plate, in accordance with the present invention, for blocking the flow of eddy currents.

FIG. 3 is a perspective of a second embodiment of a structure for the pole plate, in accordance with the present invention, for blocking the flow of eddy currents.

### DESCRIPTION OF THE PREFERRED EMBODIMENTS

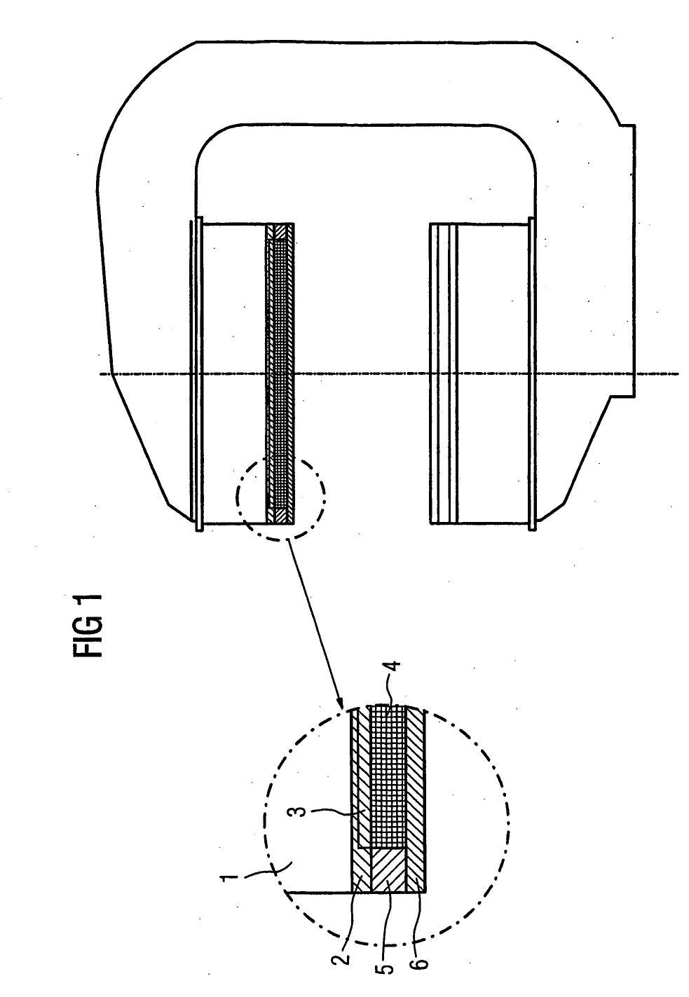

FIG. 1 shows that each pole of the C-shaped magnet has a pole plate, a pole piece, a shimming ring and a gradient coil. As can be seen from the enlarged portion to the left of FIG. 1, the magnetic generating device has a permanent magnet 1, a pole plate 2, a fragmented pole plate part 3, a pole piece 4, a shimming ring 5, or so-called Rose ring and a gradient coil 6 from top to bottom.

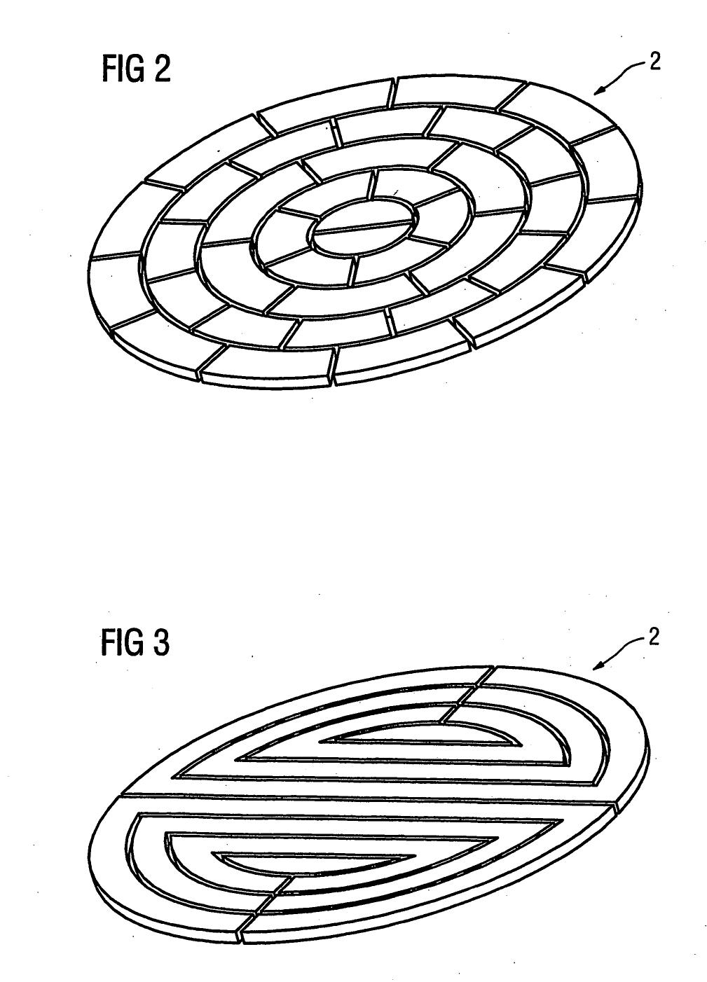

In the present invention, the pole plate could be cut into:
(1) a number of interleaving arc parts as shown in FIG. 2, but not limited to the structure of FIG. 2.
(2) a circle similar to the shape of the wire-winding pattern of the gradient coil as shown in FIG. 3, but not limited to the structure of FIG. 3.
(3) or other shapes to block the eddy current, for example, a spoke shape, etc.

As shown in FIGS. 2 and 3, the rings of the pole plate 2 have at least one gap for blocking the flow of eddy currents. The width of each ring could vary from 5 mm to 200 mm. The pole plate segment pattern formed by a plurality of arc-shaped segments could be formed by directly cutting the pole plate. The width of the gap should be less than 1 cm so as to keep the mechanical strength of the pole plate as a whole and avoid great decrease of the magneto-conductivity at the gap. Another method is to pre-fabricate a pole plate of any of the corresponding shapes directly with soft magnetic materials (such as iron, mild steel), and to fix them on the pole plate base by screws or other methods like tessellating or adhering; electrical insulation between the pole plate segments is accomplished by employing thin insulating chips or by coating insulating lacquer layer on the surface of the pole plate segments.

The advantage of the present invention is that currents and residual magnetism induced in the pole plate under the pulse gradient field are reduced, while the overall magneto-conductivity will not be greatly reduced and the strength of the pole plate needed for fixing the permanent magnet material will not be degraded.

Although modifications and changes may be suggested by those skilled in the art, it is the invention of the inventor(s) to embody within the patent warranted heron all changes and modifications as reasonably and properly come within the scope of (his/their) contribution to the art.

1-18. (canceled)

19. A magnetic field generating system for a magnetic resonance apparatus comprising:
first and second magnetic field generating assemblies separated from each other by a space therebetween, adapted to receive an examination subject therein, and connected to each other by a magnetic return;
each of said first and second magnetic field assemblies comprising a static magnetic field generating source, pulsed magnetic field excitation coils, and a pole plate disposed between the static magnetic field generating source and the pulsed magnetic field excitation coils, the respective static magnetic field generating sources, pole plates and pulsed magnetic field excitation coils in the first and second assemblies being mirror-symmetrically disposed relative to a plane proceeding through said space; and
in each of said first and second assemblies, said pole plate being comprised of a plurality of pole plate segments and having an eddy current propagation limiting structure selected from the group consisting of electrical insulation between adjacent pole plate segments, and a single electrically conductive point between adjacent pole plate segments with the respective single conducting points between adjacent pole plate segments with the respective single conducting points between adjacent pole plate segments not forming a complete electrically conducting loop.

20. A system as claimed in claim 19 wherein each of said pole plates comprises a plurality of interleaving arc-shaped segments, forming said pole plate segments.

21. A system as claimed in claim 19 wherein each of said pole plates comprises a plurality of circular segments resembling a gradient coil winding pattern, forming said pole plate segments.

22. A system as claimed in claim 19 wherein said pole plate segments are spoke-shaped.

23. A system as claimed in claim 19 wherein said pole plate segments have interleaving radiating shapes.

24. A system as claimed in claim 19 wherein each of said pole plates comprises a plurality of non-penetrating slits therein, forming said pole plate segments.

25. A system as claimed in claim 24 wherein said eddy current propagation limiting structure comprises insulation selected from the group consisting of an insulating chip between adjacent pole plate segments and an insulating coating at respective adjoining surfaces of adjacent pole plate segments.

26. A system as claimed in claim 19 wherein each of said pole plates comprises a pole plate base with said pole plate segments mechanically attached thereto, with each pole plate segment being pre-fabricated of a soft magnetic material.

27. A system as claimed in claim 25 wherein said eddy current propagation limiting structure comprises insulation selected from the group consisting of an insulating chip between adjacent pole plate segments and an insulating coating at respective adjoining surfaces of adjacent pole plate segments.

28. A system as claimed in claim 19 wherein said eddy current propagation limiting structure comprises insulation selected from the group consisting of an insulating chip between adjacent pole plate segments and an insulating coating at respective adjoining surfaces of adjacent pole plate segments.

29. A system as claimed in claim 19 wherein each of said pole plates segments has a width in a range between 5 mm and 200 mm, and wherein said pole plate segments are separated from each other by gaps that are less than 1 cm.

30. A system as claimed in claim 1 wherein each of said pole plates has an external edge, and wherein each of said first and second assemblies comprises a shimming ring disposed at the external edge of the pole plate in that assembly.
